(19) United States
(12) Patent Application Publication
(10) Pub. No.: US 2014/0191519 A1
(43) Pub. Date: Jul. 10, 2014

(54) Removable vehicle door security lock

(71) Applicant: SLEEPTITE, INC., Henderson, NV (US)

(72) Inventor: Betty Cutlip, Greenwood, LA (US)

(73) Assignee: SLEEPTITE, INC., Henderson, NV (US)

(21) Appl. No.: 14/152,699

(22) Filed: Jan. 10, 2014

Related U.S. Application Data
(60) Provisional application No. 61/751,075, filed on Jan. 10, 2013.

(51) Int. Cl. E05C 19/00; E05C 19/18

(52) U.S. Cl. CPC E05C 19/003; E05C 19/18
USPC 292/292

(57) ABSTRACT

A device for use by a commercial driver in securing the doors of the vehicle while in another part of the vehicle would be inserted inside of the vehicle door on each side. The device would consist of a telescoping bar with an internal spring that automatically collapses the bar when released. The adjustment arm would telescope out of the housing of the device and lock into place to extend the overall length, directly across the interior width of the vehicle. On each end, a flat, rigid paddle would slide in between the window and the inside door panel, while a pair of elongated rigid members would extend outward from the attachment point to rest against the door frame. The elongated rigid members would retract, fold in, or otherwise be actuated to release the device and allow the door to be opened.

### CROSS-REFERENCE TO RELATED APPLICATIONS

This application claims priority to U.S. Provisional Application No. 61/751,075, filed Jan. 10, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to a device for use by a vehicle driver in securing the doors of his or her vehicle while in another part of the vehicle, and in particular to a device for securing doors of a commercial truck or delivery van. Since many truck cabs and other commercial vehicles of the same make and model are keyed identically, commercial drivers are at risk of opportunistic crime by other drivers having identically keyed vehicles. Universal locksmith kits are also available to the general public for commercial trucks; no identification of ownership or proof employment as a commercial driver is necessary to obtain these kits. It is also not necessary to prove that you have locked yourself out of a commercial vehicle, before purchasing a universal locksmith kit. This creates a serious security risk for drivers and leaves drivers vulnerable to break-ins. Such crimes against commercial drivers have increased dramatically due to rising fuel costs, and the practice by many commercial drivers of keeping valuable items inside the vehicle. The device would address this problem by inserting a mechanical locking device inside of the vehicle door on each side. A simple, inexpensive, and reliable device to secure the vehicle doors while the driver is sleeping, sorting delivery packages, or otherwise occupied would be very convenient, and of great value.

### SUMMARY OF THE INVENTION

Accordingly, the invention is directed to a device for use by a commercial driver in securing the doors of his or her vehicle while in another part of the vehicle. The device would preferably be inserted inside of the vehicle door on each side. The device would consist of a telescoping bar with an internal spring that automatically collapses the bar when released. The adjustment arm would preferably telescope out of the housing of the device and lock into place to extend the overall length to a maximum of seven feet, directly across the interior width of the vehicle. On each end, a flat, rigid paddle would slide in between the window and the inside door panel, while a pair of elongated rigid members would extend outward from the attachment point to rest against the door frame. The elongated rigid members would preferably retract, fold in, or otherwise be actuated to release the device and allow the door to be opened when the user desires to exit the vehicle. Actuation would be controlled by a handle, lever, button, knob, or other mechanism at the center of the device.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawings are included to provide a further understanding of the invention and are incorporated into and constitute a part of the specification. They illustrate one embodiment of the invention and, together with the description, serve to explain the principles of the invention.

FIG. 1 shows the front view of the first exemplary embodiment displaying the device 10, the housing 11, the adjustment arm 12, the flat, rigid paddles 13, the internal spring 15, and the engagement structures 16.

FIG. 2 shows the rear angular view of the first exemplary embodiment in use, attached to the vehicle doors 14, displaying the device 10, the housing 11, and the adjustment arm 12.

FIG. 3 shows a perspective view of the second exemplary embodiment, displaying the device 10, the housing 11, the adjustment arm 12, the flat, rigid paddles 13, the engagement structures 16, and the latch mechanism 17.

FIG. 4 shows a perspective view of the third exemplary embodiment, displaying the device 10, the housing 11, the adjustment arm 12, the flat, rigid paddles 13, the engagement structures 16, and the latch mechanism 17.

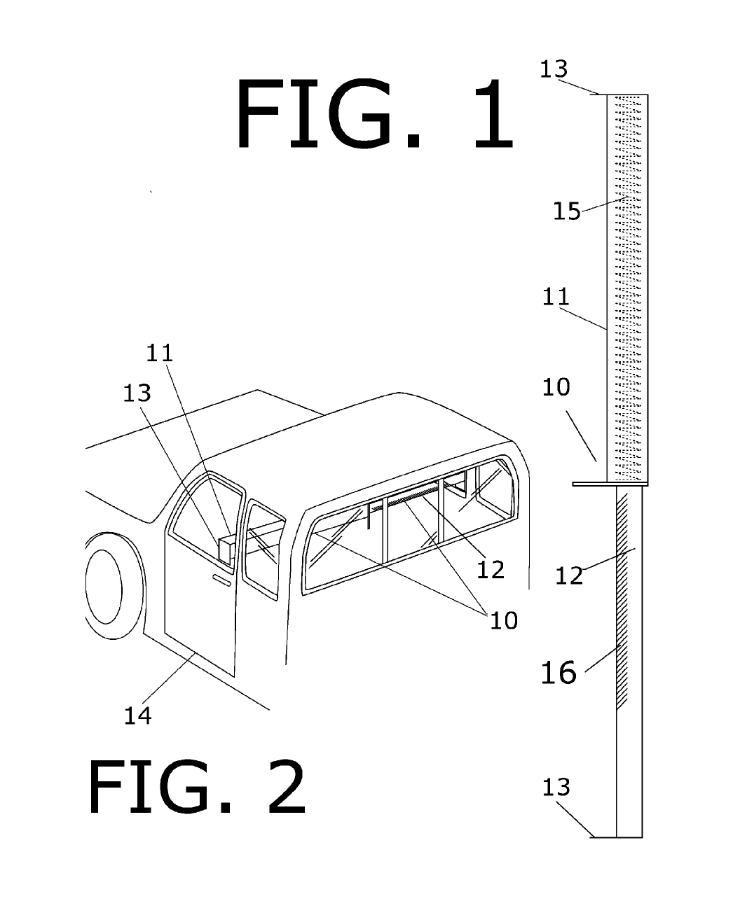

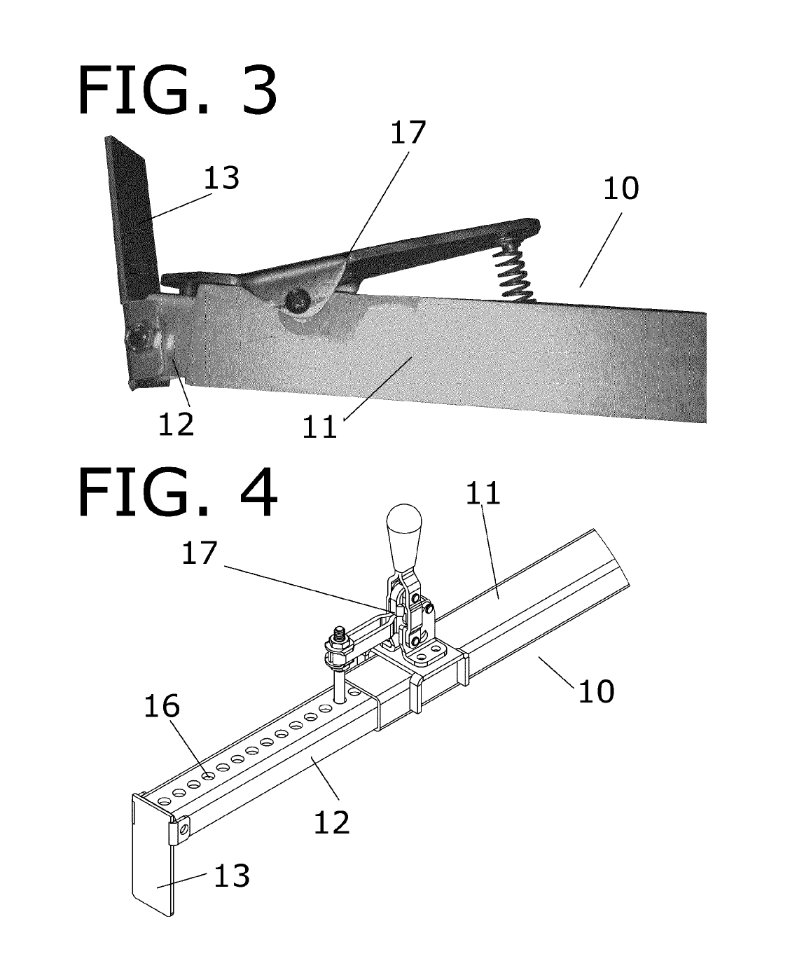

### DETAILED DESCRIPTION OF THE INVENTION

Referring now to the invention in more detail, the invention is directed to a device 10 for use by a commercial driver in securing the doors 14 of his or her vehicle cab while in another part of the vehicle. Installation of the device 10 preferably causes the doors 14 to pull against each other when a person outside the vehicle attempts to open a door. The device 10 would preferably be placed inside of the vehicle door 14. The device 10 would comprise a telescoping bar with an internal spring that automatically collapses the bar. The adjustment arm 12 telescopes out of the housing 11 of the device 10, and locks into place to extend overall length to a maximum of seven feet, directly across the interior width of the vehicle. The user would preferably extend the adjustment arm 12 out of the housing 11 until each end of the device 10 is pressed firmly against one of the windows, and the adjustment arm 12 would then be locked into place with a button, knob or similar mechanism at the center of the extended device 10. An internal spring 15 would preferably extend as the adjustment arm 12 telescopes out. The internal spring 15 would preferably latch into place securely with a self-engaging latch mechanism 17, which would engage with the engagement structures 16 on the adjustment arm 12. The engagement structures 16 may take the form of notches, teeth, holes or the like, and the latch mechanism 17 may be of any type configured to engage to the particular engagement structures 16 used.

On each end of the device 10, a flat, rigid paddle 13, approximately two to three inches in length, would preferably slide in between the window and the inside door panel of the door 14, while a pair of elongated rigid members would preferably extend outward from the attachment point to rest against the door frame. The flat, rigid paddle 13 would preferably be extended from the end of the adjustment arm 12 to be inserted into the passenger door 15 of the vehicle, and from the end of the housing 11 to be inserted into the driver's door 15. The flat, rigid paddles may optionally be affixed pivotably so as to permit fine adjustment of the adjustment arm 12, thereby allowing the latch 17 to align with one of the engagement structures 16; this end may likewise be achieved by making the latch 17 adjustable relative to the housing 11. The elongated rigid members would be made to retract, fold in, or otherwise be actuated to release the device 10 and allow the door 14 to be opened when the user desires to exit the vehicle. When the adjustment arm 12 starts to retract, it will preferably release the self-engaging latch of the internal spring. The interior spring would then preferably automatically collapse the device 10 for storage when not in use.

Actuation would preferably be controlled by a handle, lever, knob, or other actuation component of the latch 17, which would be preferably located at the center of the device 10. The actuation mechanism would preferably have a spring loaded hinge mounted on each of the elongated rigid members. This would prevent a burglar from gaining entry by breaking a window, reaching in, and manually actuating the device 10 to disengage it from the door frame. When extended, the adjustment arm 12 would be spring loaded for quick release and retraction.

The locking mechanism 17 will lock into place by engagement with the engagement structures 16 at the center of the bar of the interior telescope by a handle, lever, button, knob or other mechanism, thereby making it a quick release by intention. This is important due to safety issues that a driver may incur while in the vehicle, i.e. a fire where smoke is an issue and visibility is nil.

The device 10 would preferably be manufactured from durable, rigid materials with high tensile and shear strength such as steel or aluminum. It would preferably be painted orange or a similarly bright color, with stickers of the same color to be mounted on the windows of both doors 14, announcing that the locking bar is in use. These warnings would preferably act as a deterrent to burglars and would also be clearly visible to emergency personnel. Each end of the device 10, and the end of each elongated rigid member would preferably be covered with a soft, spongy cap, composed of rubber or similar material, to protect the vehicle windows and door frames.

The intended application of the preferred embodiment extends not only to large truck cabs, but also small trucks, vans, and passenger cars, as well as aircraft and watercraft cockpits and cabins.

Component materials and sizes listed above are preferable, but artisans will recognize that alternative components could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A vehicle security device comprising:
(a) a housing;
(b) said housing being hollow;
(c) an adjustment arm;
(d) said adjustment arm being slidably disposed within said housing;
(e) said adjustment arm being shaped to include a plurality of engagement structures;
(f) a latch mechanism;
(g) said latch mechanism being configured to engage with said engagement structures;
(h) said latch mechanism being affixed to said housing such that said latch mechanism may be engaged to said engagement structures of said adjustment arm;
(i) a pair of paddles;
(j) one of said pair of paddles being affixed to said housing;
(k) one of said pair of paddles being affixed to said adjustment arm;
(l) a spring; and
(m) said spring being affixed within said housing and to said adjustment arm such that said adjustment arm is urged into said housing;
whereby said paddles may be engaged between the windows and inside door panels of a vehicle cabin, thereby securing the doors of said vehicle cabin in a closed position from the inside.

2. The vehicle security device of claim 1 wherein said latch is self-engaging;

3. A method of using the vehicle security device of claim 1 comprising:
(a) engaging said pair of paddles between the window and inside door panel on each side of said vehicle cabin, thereby extending said adjustment arm out from said housing against the force of said spring;
(b) engaging said latch to said plurality of said engagement structures;
(c) remaining in said vehicle cab securely, until desiring to exit;
(d) disengaging said latch from said engagement structures; and
(e) disengaging said pair of paddles from between the window and inside door panel on each side of said vehicle cabin.

4. A method of using the vehicle security device of claim 2 comprising:
(a) engaging said pair of paddles between the window and inside door panel on each side of said vehicle cabin, thereby extending said adjustment arm out from said housing against the force of said spring;
(b) engaging said latch to said plurality of said engagement structures;
(c) remaining in said vehicle cab securely, until desiring to exit;
(d) disengaging said latch from said engagement structures; and
(e) disengaging said pair of paddles from between the window and inside door panel on each side of said vehicle cabin.
